(19) United States
(12) Patent Application Publication
(10) Pub. No.: US 2011/0197936 A1
(43) Pub. Date: Aug. 18, 2011

(54) DEVICE FOR CLEANING/WASHING OF CARGO HOLDS ONBOARD DRY CARGO VESSELS

(76) Inventors: Bent Lorentz-Larssen, Oslo (NO); Ernst Johnny Svelund, Tustna (NO)

(21) Appl. No.: 13/123,930

(22) PCT Filed: Oct. 8, 2009
(86) PCT No.: PCT/NO2009/000348

§ 371 Date: May 6, 2011

(30) Foreign Application Priority Data
Oct. 14, 2008 (NO) 20084305

(51) Int. Cl. B08B 9/00

(52) U.S. Cl. 134/167 R

(57) ABSTRACT

This invention consists of a device for washing/cleaning of cargo holds onboard dry cargo vessels, where the device (50) is arranged at the extreme front end of a suitable trolley (40), which is in turn secured on the edge of the vessels cargo hold hatch (41) in such a way that the device may be lowered down between the cargo hold hatches (41), (42) whereupon the rotating portion of the washing device (1) rotates whilst pressurized water (16) exits from a nozzle (22) which is arranged at the end of the washing arm (20) concurrently with the washing arm (20) being gradually lowered so that the entire cargo hold is washed/cleaned from the top and down. After completion of the washing process the rotating portion of the device (1) may be raised so that the entire device can be repositioned to the next cargo hold, after being disengaged from the hatch cover. Repositioning from one cargo hold to the next may be accomplished manually by rolling the entire device over a custom ladder (130) which is positioned onto and between each of the cargo hold hatch covers. The invention may be adapted to all types of vessels.

The conventional method for cleaning of cargo hold onboard vessels is manual washing with hoses by the vessels crew positioned at the bottom of the vessels cargo hold. This method entails considerable time usage, and subsequently protracted costs, in part due to the vessel not being fit/ready for loading of cargo. There exist alternative technical solutions that must be positioned on the cargo hold hatches to facilitate washing of dry cargo holds. These solutions, U.S. Pat. No. 4,220,170—JP 63184593—EP 0111014 A1, constitute a device positioned at the front of a cargo hatch, but that is unable to rotate the water jet more than approx. 360° in any given direction for the purpose of washing the cargo hold, simultaneously as the water jet is raised or lowered vertically during the tank washing process. None of the solutions in existence can be repositioned from one set of hatches to another or from the vessels deck up onto the hatch cover, or from the hatch cover down to the vessels deck in a simple fashion, as they are not designed with a suitable mobile trolley.

The following invention is characterized by a washing device that is secured on to the edge of the hatch covers, from where the jet of water is distributed into the cargo hold from an elevated position. Current manual washing methods entail manual hosing from the bottom of the cargo hold, from where the jet of water looses much of its energy overcoming the force of gravity on its way upward. Manual washing with hand held hoses also sets limits the amount of water and water pressure used in order for the crewmember to be able to overcome the reaction impulse of the water jet exiting the hose. A washing system that is secured in an elevated position on the hatch covers is able to eliminate the above mentioned negative factors. The following device will both reduce the time used for washing of the cargo holds, as well as enabling washing of, and access to areas of the cargo hold that are difficult to access using traditional manual washing methods.

This is obtained as the washing device is arranged to a special trolley which is secured on the extreme edge of the hatch cover, where the device can be lowered down between the hatch covers, where the rotating part of the washing device rotates concurrently with pressurized water exiting from a muzzle fixed at the end of a washing arm that is gradually lowered in such a way that the entire cargo hold is cleaned from top to bottom. When the washing process is complete the rotary part of the washing device is raised in order for it to be repositioned to the next cargo hold after the trolley it is arranged to is disconnected from its fixtures on the cargo hatch cover. Repositioning to the next cargo hold is facilitated manually by rolling the trolley carrying the washing device over a special bridging unit that is positioned between the individual cargo hold hatch covers. The invention can be adapted to any type of vessel.

The invention is further described with examples and figures in the following section where:

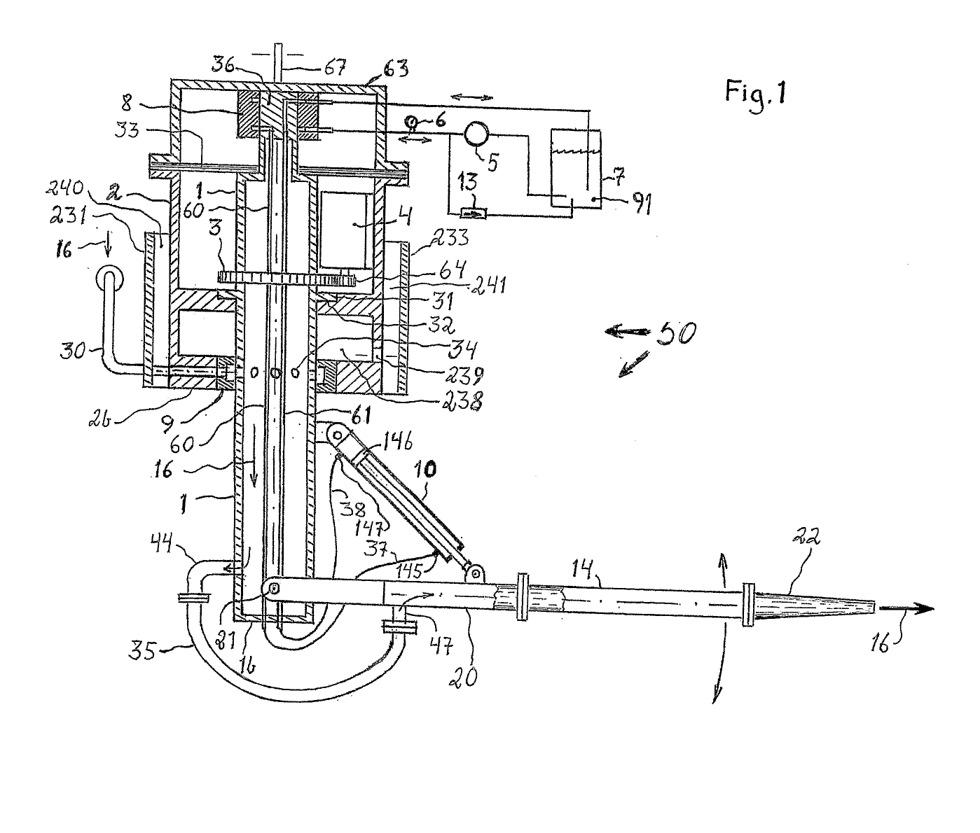

FIG. 1 depicts a side view of the actual rotatable washing device.

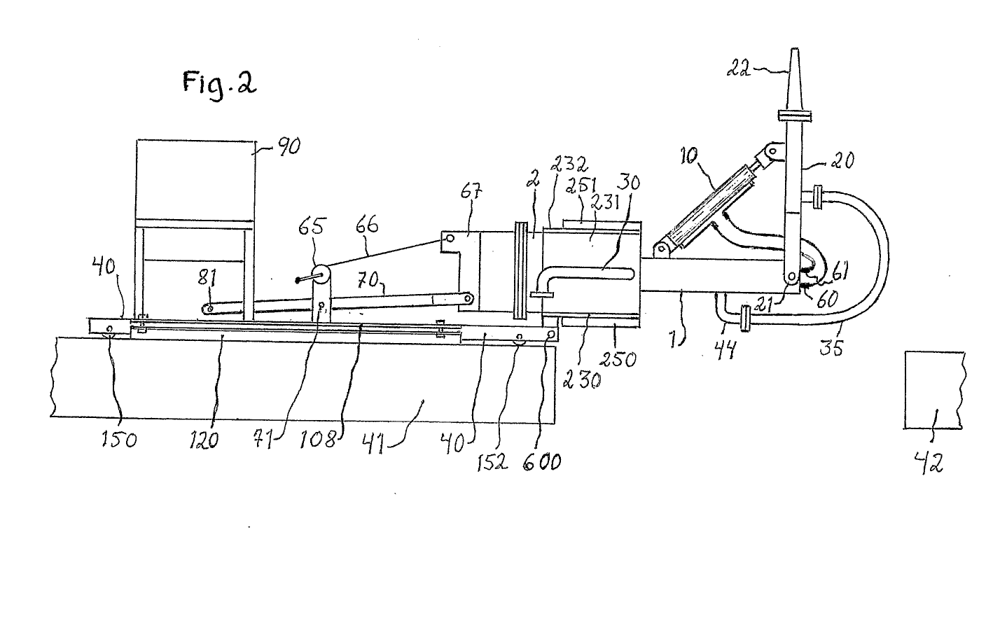

FIG. 2 depicts how the washing device rests in raised position on its special trolley secured at the extreme edge of a cargo hold hatch cover.

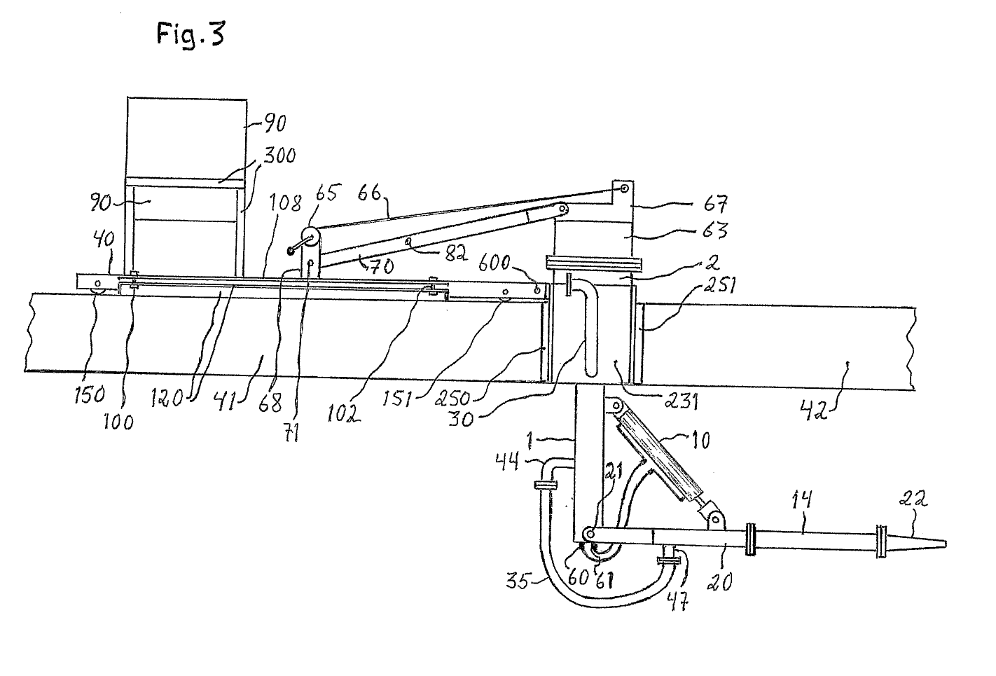

FIG. 3 depicts the washing device lowered into the cargo hold ready for washing operation.

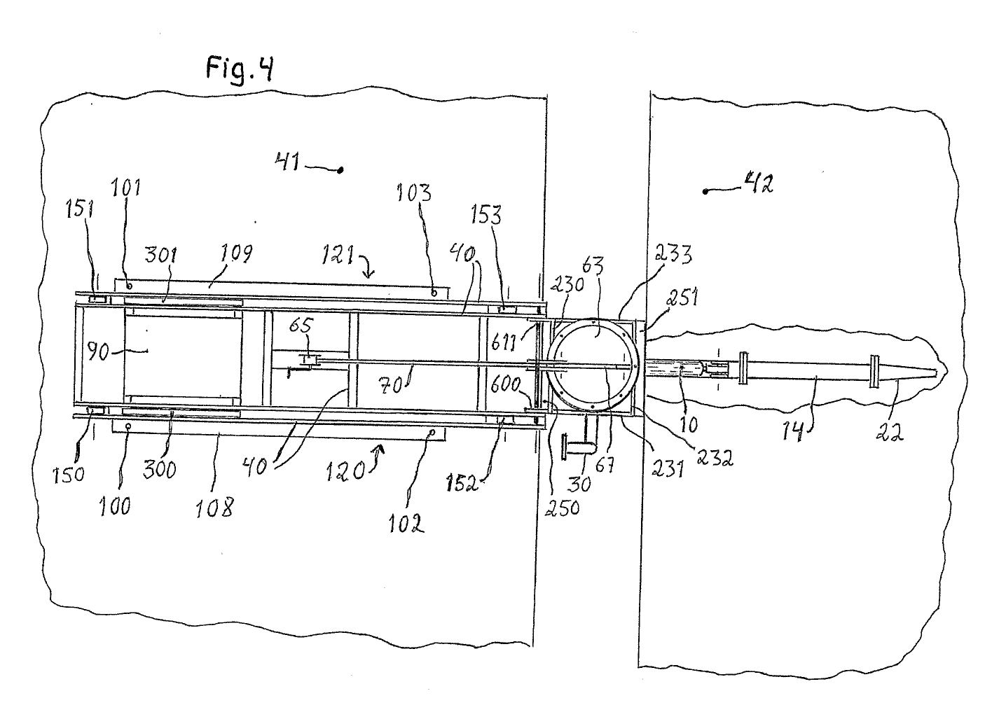

FIG. 4 depicts the same as FIG. 3, seen from a bird's eye perspective.

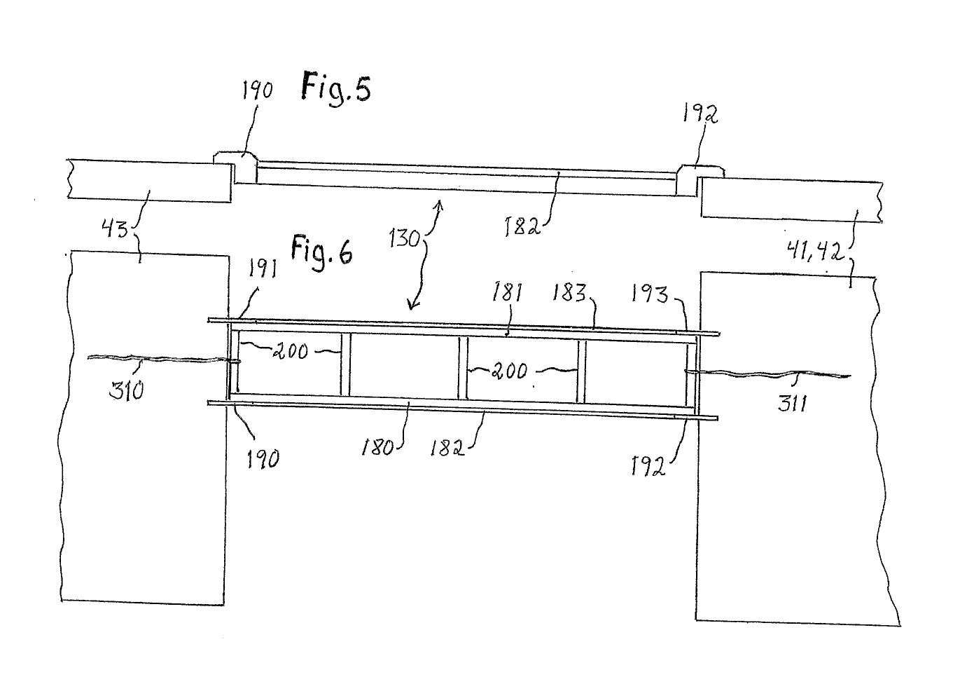

FIG. 5 depicts a side view of the bridging device positioned between and onto two hatch covers between to individual cargo holds.

FIG. 6 depicts the same as FIG. 5, but seen from a bird's eye perspective.

Please observe FIGS. 1, 2, 3 and 4. The water supply tube 1 is arranged to an external seat ring 31 that rests onto a custom lower non-rotatable seat ring 32 arranged to the stator 2 whereas the upper part of the water supply tube 1 is constricted and rests onto an above non-rotary seat disc 33 arranged to the upper part of the stator 2 between the stator and a stator hat 63, where the stator hat 63 is arranged to the stator 2 for example via bolts where the incoming water 16 is distributed to the washing arm 20 initially through an exterior inlet tube 30 arranged to the lower part of the stator 2 and further via a non-rotary water slide 9 arranged to the stator 2 or the bottom 2b of the stator 2, which rests outside the rotary water supply tube 1 and further is distributed to the inside of the water supply tube 1 through perforations 23 in the water supply tube 1 and further through a flexible water supply hose 35 arranged to the lower part of the water supply tube 1 to an exit tube 44, alternatively via a removable halter arranged around the water supply tube 1 and further to the inlet 47 of the washing arm 20 and that between the water slide 9 and the above seat ring 32 exists a circular chamber 238 between the stator tube 2 and the water supply tube 1 with drainage perforations 239 in the lower part of the stator tube 2 immediately above the water slide 9 where a hydraulic pump 5, powered by a suitable motor—for example a rpm. and frequency regulated, electric motor—raises and lowers the washing arm 20 as hydraulic oil is being forced to and from the hydraulic jack cylinder 10 initially via a non-rotary hydraulic slide 8 arranged to the stator hat 63, or to the non-rotary seat disc 33, where the rotating part 36 of the slide 8 is arranged to the water supply tube 1 and to the jack cylinder 10 initially via hydraulic tubes 60,61 arranged to the inside of the water supply tube 1 and finally via flexible hydraulic hoses 37,38 arranged to the ends of the hydraulic tubes 60,61 which go through the bottom 1b of the water supply tube 1, and into the jack cylinder 10 where the high pressure inlet 145 is arranged to the end of the jack on the underside of the jack piston 146, whilst the low pressure inlet 147 is arranged at the opposite end of the jack cylinder 10 on top of the jack piston 146 where the water supply tube 1 is made to rotate by way of a suitable motor 4—for example a rpm. and frequency regulated, electric motor 4, arranged to and on the inside of the stator 2 or to a rectangular gusset plate bolted to the exterior of and onto a frame arranged to the stator tube 2, where the motor gear 64, preferably a cylindrical gear 6 with straight or offset teeth, grabs into a suitable gear 3 arranged around the exterior and onto the water supply tube 1 above the seat ring 31 and that on the exterior onto the stator 2 there is arranged a reinforcement frame consisting of four solid reinforcement plates 230,231,232,233, where there between and in the middle of these reinforcement plates and the stator 2 may be arranged distancing arrangements 240,241, and that on the exterior of the two reinforcement plates 231,233 is arranged a shock absorbing material, for example consisting of rubber or wooden material, which the cargo hold hatches 41,42 may rest against during the washing process.

The rotary and submersible washing device 50 is arranged at the extreme front of a suitable trolley 40—equipped with wheels 150,151,152,153 in each corner—by way of hinges 600,611 arranged to the stator 2—which in turn is arranged onto and on top of the edge of the cargo hold hatches 41 in such a way that the washing device may be tilted down into the cargo hold in the same way as an outboard engine on a motorboat, whereby the washing device 50 in submersed position may distribute the water 16 horizontally, or alternatively somewhat vertically up to the cargo hold hatches 41,42, and out to the sides of the cargo hold walls via a nozzle 22 arranged to the washing arm 20, alternatively via an extension tube 14, hinged 21 in the lowermost part and at either side to the rotary part of the washing device 50, alternatively via a removable halter arranged around the water supply tube 1, consisting of a water supply tube 1 where a hydraulic jack cylinder 10, arranged to the washing arm 20 alternatively via a removable halter arranged around the water supply tube 1 and onto the upper part of the rotatable water supply tube 1 ensures that the washing arm 20 is lowered gradually as the water supply tube 1 rotates around in the cargo hold just below the cargo hold hatches 41,42.

The washing device 50 may be raised and lowered by means of a winch 65 arranged approx. in the middle of the trolley 40 on top of an intermediate winch foot 68 where the winch wire 66 or strap 66 is arranged at the back of an supporting plate 67 arranged on top of the stator hat 63 arranged to the stator 2, and that a support beam 70 is arranged at the front of the supporting plate that is led through the centre of the winch foot 68 where a locking pin 71 which passes through the winch foot 68 and a hole 82 further in on the support beam 70 when the washing device 50 is in the raised position, or that the support beam constitutes a hydraulic jack cylinder 70 arranged to the winch foot 68 and to the supporting plate 67, which may raise and lower the washing device 50.

An instrumentation locker is arranged at the opposite end of the trolley 40 where the motor—for example an rpm. and frequency regulated electrical motor—an expansion tank 7 for the re-circulated hydraulic oil 91, a pressure sensor 6 attached to the high pressure zone of the hydraulic circuit, a pressure activated return valve 13 connected to the high pressure zone of the hydraulic circuit, external electrical connectors for electrical power supply to run the hydraulic pump 5 and the motor 4 that enables rotation of the water supply tube 1, as well as a computer that synchronizes the working cycle of the washing device 50, and that on either side of the trolley are arranged banisters 300,301.

A computer controls the washing device 50 work process, whereby the water supply tube 1 with the washing arm 20 rotates around inside the cargo hold whilst it is gradually lowered, alternatively that the water supply tube 1 with the washing arm 20 is raised and lowered vertically during the washing process whilst the washing arm 20 quantitatively rotates something which is obtained when the computer is connected to the motor which powers the hydraulic pump 5, to the pressure sensor 6, and to the motor 4 which is connected to the rotatable water supply tube 1 via the gear 3 which is arranged to and around the water supply tube 1.

The trolley 40 is secured to the cargo hold hatch covers 41, 42 by way of bolts 100,101,102,103, or by way of electromagnets, arranged at either end of the trolley 40, which are led via suitable holes 104,105,106,107 in two rails 108,109 arranged along and at either side of the trolley 40 and through a set of holes or longitudinal tracks in two longitudinal rails 120,121 secured onto each of the vessels cargo hold hatch covers 41,42 with a suitable distance at the extreme front of each hatch cover, and that a suitable ladder 130—a ladder consisting of two longitudinal tracks 180,181, with intermediate reinforcements 200, resting between two individual cargo hold hatch covers, and which creates a level surface with the deck of the hatch covers where the ladders extremities rest against and remain stable to the sides of the hatch covers by way of external longitudinal edge supports 182,183 arranged to the tracks, protruding slightly higher than the actual tracks, were at either end of the side of the tracks is arranged suitable hooks 190,191,192,193, with intermediate distancing plates or distancing arrangements (not shown in figure) between the tracks 180,181 and the hooks 190,191,192,193 which rest against the upper edge of the hatch covers—positioned between each of the hatch covers between two individual cargo holds when the trolley 40 carrying the washing device 50 is to be repositioned to another cargo hold 43 onboard a vessel.

The washing device 50 with or without the trolley 40 can be secured on top of the hatch covers 41,42,43 approx. in the centre of the cargo hold during the washing process.

A set of straps may be affixed to the trolley 40 at either end. These straps may be used when the trolley 40 carrying the washing device 50 is to be rolled over the ladder 130 from one hatch to the next. The strap may be thrown over to the opposite side of the hatch cover whereby a crewmember can pull the trolley over the ladder whilst another crewmember may control the other strap from a position on the hatch cover which the trolley is repositioned from. Straps may also be fastened to the ladder 130 in such a way that the crewmembers positioned on top of the hatch covers in a simple and controlled fashion may install the ladder between the individual cargo hold hatch covers.

1. Device for cleaning/washing of dry bulk carrier cargo holds, where existing solutions consist of a device arranged at the front end of a cargo hatch, but which is unable to rotate the jet of water continuously more than approx. 360° in each direction for the purpose of washing of a dry bulk carrier cargo hold, whilst simultaneously raising and lowering the jet of water vertically under such washing operation, where the washing device (50)—mainly consisting of a non-rotary cylindrical stator tube (2) which is of a greater diameter and positioned on the outside of the upper portion of a rotary water supply tube (1), characterized by the water supply tube (1) being arranged with an external seat ring (31) which rests onto a custom lower non-rotary seat ring (32) arranged to the stator (2) whereby the upper part of the water supply tube (1) is constricted and rests onto an above non-rotary seat disc (33) arranged to the upper part of the stator (2) between the stator and a stator hat (63), where the stator hat (63) is arranged to the stator (2) for example via bolts where the incoming water (16) is distributed to the washing arm (20) initially through an exterior inlet tube (30) arranged to the lower part of the stator (2) and further via a non-rotary water slide (9) arranged to the stator (2) or the bottom (2b) of the stator (2), which rests outside the rotary water supply tube (1) and further is distributed to the inside of the water supply tube (1) through perforations (2)3 in the water supply tube (1) and further through a flexible water supply hose (35) arranged to the lower part of the water supply tube (1) to an exit tube (44), alternatively via a removable halter arranged around the water supply tube (1) and further to the inlet (47) of the washing arm (20) and that between the water slide (9) and the above seat ring (32) exists a circular chamber (238) between the stator tube (2) and the water supply tube (1) with drainage perforations (239) in the lower part of the stator tube (2) immediately above the water slide (9) where a hydraulic pump (5), powered by a suitable motor—for example a rpm. and frequency regulated, electric motor—raises and lowers the washing arm (20) as hydraulic oil is being forced to and from the hydraulic jack cylinder (10) initially via a non-rotary hydraulic slide (8) arranged to the stator hat (63), or to the non-rotary seat disc (33), where the rotating part (36) of the slide (8) is arranged to the water supply tube (1) and to the jack cylinder (10) initially via hydraulic tubes (60),(61) arranged to the inside of the water supply tube (1) and finally via flexible hydraulic hoses (37),(38) arranged to the ends of the hydraulic tubes (60),(61) which go through the bottom (1b) of the water supply tube (1), and into the jack cylinder (10) where the high pressure inlet (145) is arranged to the end of the jack on the underside of the jack piston (146), whilst the low pressure inlet (147) is arranged at the opposite end of the jack cylinder (10) on top of the jack piston (146) where the water supply tube (1) is made to rotate by way of a suitable motor (4)—for example a rpm. and frequency regulated, electric motor (4), arranged to and on the inside of the stator (2) or to a rectangular gusset plate bolted to the exterior of and onto a frame arranged to the stator tube (2), where the motor gear (64), preferably a cylindrical gear (6) with straight or offset teeth, grabs into a suitable gear (3) arranged around the exterior and onto the water supply tube (1) above the seat ring (31) and that on the exterior onto the stator (2) there is arranged a reinforcement frame consisting of four solid reinforcement plates (230),(231),(232),(233), where there between and in the middle of these reinforcement plates and the stator (2) may be arranged distancing arrangements (240),(241), and that on the exterior of the two reinforcement plates (231),(233) is arranged a shock absorbing material, for example consisting of rubber or wooden material, which the cargo hold hatches (41),(42) may rest against during the washing process.

2. Device for washing/cleaning of dry bulk carrier cargo holds according to claim 1, characterized by the fact that the rotary and submersible washing device (50) is arranged at the extreme front of a suitable trolley (40)—equipped with wheels (150),(151),(152),(153) in each corner—by way of hinges (600),(611) arranged to the stator (2)—which in turn is arranged onto and on top of the edge of the cargo hold hatches (41) in such a way that the washing device may be tilted down into the cargo hold in the same way as an outboard engine on a motorboat, whereby the washing device (50) in submersed position may distribute the water (16) horizontally, or alternatively somewhat vertically up to the cargo hold hatches (41),(42), and out to the sides of the cargo hold walls via a nozzle (22) arranged to the washing arm (20), alternatively via an extension tube (14), hinged (21) in the lowermost part and at either side to the rotary part of the washing device (50), alternatively via a removable halter arranged around the water supply tube (1), consisting of a water supply tube (1) where a hydraulic jack cylinder (10), arranged to the washing arm (20) alternatively via a removable halter arranged around the water supply tube (1) and onto the upper part of the rotatable water supply tube (1) ensures that the washing arm (20) is lowered gradually as the water supply tube (1) rotates around in the cargo hold just below the cargo hold hatches (41),(42).

3. Device for washing/cleaning of dry bulk carrier cargo holds according to claims 1-2, characterized by the fact that the washing device (50) may be raised and lowered by means of a winch (65) arranged approx. in the middle of the trolley (40) on top of an intermediate winch foot (68) where the winch wire (66) or strap (66) is arranged at the back of an supporting plate (67) arranged on top of the stator hat (63) arranged to the stator (2), and that a support beam (70) is arranged at the front of the supporting plate that is led through the centre of the winch foot (68) where a locking pin (71) which passes through the winch foot (68) and a hole (82) further in on the support beam (70) when the washing device (50) is in the raised position, or that the support beam constitutes a hydraulic jack cylinder (70) arranged to the winch foot (68) and to the supporting plate (67), which may raise and lower the washing device 50.

4. Device for washing/cleaning of dry bulk carrier cargo holds according to claims 1-3, characterized by the fact than an instrumentation locker is arranged at the opposite end of the trolley (40) where the motor—for example an rpm. and frequency regulated electrical motor—an expansion tank (7) for the re-circulated hydraulic oil (91), a pressure sensor (6) attached to the high pressure zone of the hydraulic circuit, a pressure activated return valve (13) connected to the high pressure zone of the hydraulic circuit, external electrical connectors for electrical power supply to run the hydraulic pump (5) and the motor (4) that enables rotation of the water supply tube (1), as well as a computer that synchronizes the working cycle of the washing device (50), and that on either side of the trolley are arranged banisters (300),(301).

5. Device for washing/cleaning of dry bulk carrier cargo holds according to claims 1-4, characterized by the fact that a computer controls the washing device (50) work process, whereby the water supply tube (1) with the washing arm (20) rotates around inside the cargo hold whilst it is gradually lowered, alternatively that the water supply tube (1) with the washing arm (20) is raised and lowered vertically during the washing process whilst the washing arm (20) quantitatively rotates, something which is obtained when the computer is connected to the motor which powers the hydraulic pump (5), to the pressure sensor (6), and to the motor (4) which is connected to the rotatable water supply tube (1) via the gear (3) which is arranged to and around the water supply tube (1).

6. Device for washing/cleaning of dry bulk carrier cargo holds according to claims 1-5, characterized by the fact that the trolley (40) is secured to the cargo hold hatch covers (41),(42) by a number of bolts (100),(101),(102),(103), or by way of electromagnets, arranged at either end of the trolley (40), which are led via suitable holes (104),(105),(106),(107) in two rails (108),(109) arranged along and at either side of the trolley (40) and through a set of holes or longitudinal tracks in two longitudinal rails (120),(121) secured onto each of the vessels cargo hold hatch covers (41),(42) with a suitable distance at the extreme front of each hatch cover, and that a suitable ladder (130)—a ladder consisting of two longitudinal tracks (180),(181), with intermediate reinforcements (200), resting between two individual cargo hold hatch covers, and which creates a level surface with the deck of the hatch covers where the ladders extremities rest against and remain stable to the sides of the hatch covers by way of external longitudinal edge supports (182),(183) arranged to the tracks, protruding slightly higher than the actual tracks, were at either end of the side of the tracks is arranged suitable hooks (190),(191),(192),(193), with intermediate distancing plates or distancing arrangements (not shown in figure) between the tracks (180),(181) and the hooks (190),(191),(192),(193) which rest against the upper edge of the hatch covers—positioned between each of the hatch covers between two individual cargo holds when the trolley (40) carrying the washing device (50) is to be repositioned to another cargo hold (43) onboard a vessel.

7. Device for washing/cleaning of dry bulk carrier cargo holds according to claims 1-6, characterized by the fact that the washing device (50) with or without the trolley (40) can be secured on top of the hatch covers (41),(42),(43) approx. in the centre of the cargo hold during the washing process.
